(19) United States
(12) Patent Application Publication
(10) Pub. No.: US 2024/0143620 A1
(43) Pub. Date: May 2, 2024

(54) OBJECT ACCESS BASED ON TRACKING OF OBJECTS AND REPLICATION POLICIES

(71) Applicant: HEWLETT PACKARD ENTERPRISE DEVELOPMENT LP, Houston, TX (US)

(72) Inventor: Ayman Abouelwafa, Folsom, CA (US)

(21) Appl. No.: 18/051,046

(22) Filed: Oct. 31, 2022

(51) Int. Cl. G06F 16/27

(52) U.S. Cl. CPC G06F 16/27

(57) ABSTRACT

In some examples, a system tracks, in tracking information stored by the system, additions and deletions of objects in a plurality of object stores that are associated with respective control interfaces that control access of the objects in the plurality of object stores, the tracking information identifying a respective object store in which a respective object is stored, and a replication policy for the respective object, the replication policy defining how the respective object is replicated across the plurality of object stores. The system receives, from the control interfaces, indications of additions or deletions of objects in the plurality of object stores, and updates, at the system, the tracking information in response to the received indications.

### BACKGROUND

A storage system is used to store data for computing devices. In some examples, the storage system is accessible over a network by the computing devices. In further examples, multiple storage systems may be accessible over a network. Some storage systems may be located at different geographic locations, while other storage systems may be located within the same facility.

### BRIEF DESCRIPTION OF THE DRAWINGS

Some implementations of the present disclosure are described with respect to the following figures.

FIG. 1 is a block diagram of an arrangement that includes an object access redirector and object stores that are accessible by various host systems, according to some examples.

FIGS. 2A and 2B are block diagrams of tracking information according to some examples.

FIG. 3 is a flow diagram of an indexing process, according to some examples.

FIG. 4 is a flow diagram of an object access process, according to some examples.

FIG. 5 is a flow diagram of a process to recover from an object access redirector being down, according to some examples.

FIG. 6 is a block diagram of a storage medium storing machine-readable instructions according to some examples.

FIG. 7 is a block diagram of a system according to some examples.

FIG. 8 is a flow diagram of a process according to some examples.

Throughout the drawings, identical reference numbers designate similar, but not necessarily identical, elements. The figures are not necessarily to scale, and the size of some parts may be exaggerated to more clearly illustrate the example shown. Moreover, the drawings provide examples and/or implementations consistent with the description; however, the description is not limited to the examples and/or implementations provided in the drawings.

### DETAILED DESCRIPTION

In the present disclosure, use of the term “a,” “an,” or “the” is intended to include the plural forms as well, unless the context clearly indicates otherwise. Also, the term “includes,” “including,” “comprises,” “comprising,” “have,” or “having” when used in this disclosure specifies the presence of the stated elements, but do not preclude the presence or addition of other elements.

Storage systems may be used to store objects, where an “object” can refer to any separately identifiable or addressable unit of data. For example, an object can be in any of the following forms: a file, a file system, a block of data, an image, a database, a portion of a database, a chunk of data, a data blob, an audio file, a video file, an image file, or any other unit of data.

In some examples, objects stored by storage systems can be according to a Simple Storage Service (S3) standard first provided by Amazon Web Services (AWS). An S3 object can be in the form of a key-value pair, where the key includes a name assigned to an object plus other relevant metadata, and the value includes the content of the object being stored.

Although reference made to S3 objects in some examples, it is noted that in other examples, storage systems can store data according to other types of object access protocols.

A storage system that stores objects can be referred to as an “object store.” A storage system (or an object store) can include a storage controller used to perform accesses (reads or writes) of objects stored on a storage system. In some cases, the storage system can also include the storage medium used to store the objects. In other examples, the storage medium may be separate from the storage system, but is accessible by the storage controller of the storage system. A storage system can receive input/output (I/O) requests (read requests or write requests), and in response, the storage controller of the storage system can issue corresponding commands to read or write data on the corresponding storage medium.

A storage medium can be implemented using a collection of storage devices (a single storage device or multiple storage devices). A storage device can be implemented using any or some combination of the following: a disk-based storage device, a solid-state drive, or any other type of storage device.

In some examples, multiple object stores can be accessible by host systems. A “host system” can refer to any electronic device that is able to read and/or write data. Examples of electronic devices include any or some combination of the following: a supercomputer, a desktop computer, a notebook computer, a tablet computer, a server computer, a storage controller, a communication node, a smartphone, a game appliance, a vehicle, a controller in a vehicle, a household appliance, and so forth.

A host system can issue an I/O request to access data in an object store. An I/O request issued by a host system can be a read request to read data in the object store, or a write request to write data in the object store.

In some examples, data redundancy can be implemented among a group of object stores. Some object stores may be located at distant geographical locations from other object stores (e.g., different parts of a state or province, different parts of a country, or different parts of the world). In other cases, some object stores may be located relatively close to one another, such as within a facility (e.g., a data center, a cloud storage farm, an office environment, etc.). By placing object stores at geographically distant locations, protection against outages of object stores at a first geographic location can be provided by allowing copies of the objects stored by the object stores at the first geographic location to be accessed from object store(s) at other geographic location(s).

Data redundancy is accomplished by copying objects maintained at one object store to one or more other object stores. Copying objects between object stores can be based on synchronous replication or asynchronous replication. With synchronous replication, a write of an object to a first object store triggers a copy of the object to be written to one or more second object stores. With synchronous replication, the write of the object to the first object store is not considered to be complete until the write of the object to the first object store completes, and a write of a copy of the object to the second object store(s) also completes.

Note that the completion of a write of an object to an object store does not mean that the object has to be written to the storage medium of the object store; in some cases, if an object store includes a nonvolatile cache memory such as a write cache, a write can be considered complete if the object is written to the write cache. The object in the write cache can be written to the storage medium of the object store at a later time.

With asynchronous replication, a write of an object to a first object store triggers a copy of the object to one or more second object stores, where the copying of the object to the one or more second object stores can be performed asynchronously with respect to the write of the object to the first object store; in other words, the write can be considered to be complete when the write completes at the first object store, but when the copying of the object to the one or more second object stores has not yet completed or even started.

Depending upon the replication policy, certain objects may not be replicated to some of the object stores. For example, a replication policy for a given object may specify that a write of the given object to a first object store will cause a copy of the given object to be provided to a second object store. However, a third object store may not receive a copy of the object. Thus, if a host system attempts to access the given object from the third object store, the third object store may return an object not found error.

As used here, an “object not found error” can refer to any indication returned by an object store indicating that a requested object is not present or is inaccessible at the object store.

As another example, a further object may be associated with a no replication policy (i.e., the further object is not to be replicated). Thus, the further object may be written to one of the object stores but not copied to other object stores. Thus, an attempt by a host system to access the further object from one of the other object stores will result in an object not found error.

In further examples, active-active replication can be provided in which replicas of each object are accessible (e.g., for reads and writes) by a host system at any of the active object stores. An active-active arrangement is distinguished from an active-standby arrangement, where a host system can access objects from the active object store but not from the standby object store, unless the active object store becomes unavailable. When data replication is performed among a group of object stores (such as when active-active replication is performed or synchronous replication is performed between object stores), one of the object stores may go down (or communication links between object stores may go down). In such cases, to protect data consistency, host systems attempting to access the remaining object stores may be blocked until the given object store comes back up and objects are synchronized among the group of object stores. During this time, attempts to access objects of the remaining object stores may result in object not found errors.

An object store being “down” can refer to the object store being in a state where the object store is non-responsive to a request to access an object. The object store may be powered off or in a sleep state, or the object store may have experienced a fault (a program fault or a hardware fault) that prevents further operations of the object store. A communication link to an object store being “down” can result from a hardware fault or a program fault associated with the communication link.

If a host system receives an object not found error in response to attempting to access an object at an object store, that may cause the host system to cease operations or crash. This can result in delays or faults at the host system.

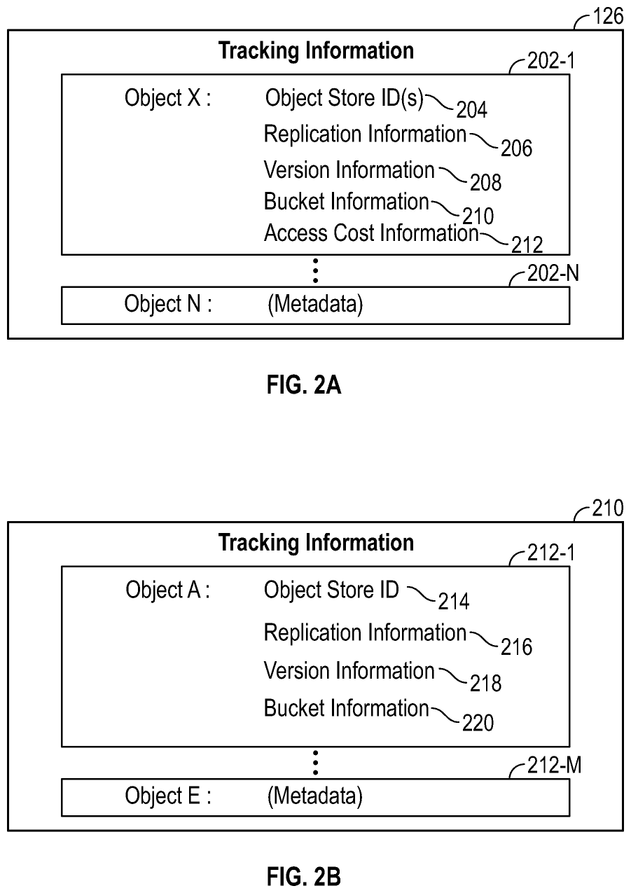

In accordance with some implementations of the present disclosure, an object access redirector (ORD) is able to track, in tracking information stored in a storage of the ORD, additions of objects to and deletions of objects from a plurality of object stores that are associated with respective control interfaces. Examples of the tracking information at the ORD are discussed in connection with FIG. 2A. The tracking information identifies a respective object store in which a respective object is stored, and a replication policy for the respective object. The tracking information does not contain the objects themselves. As a result, the ORD is lightweight, and can be implemented on any of various platforms, such as switches or other types of computing systems. The ORD receives, from the control interfaces, indications of additions of objects to or deletions of objects from any of the plurality of object stores, and may update the tracking information in response to the received indications.

The tracking information stored by the ORD is associated with objects in a transient condition. An object is considered to be in a transient condition when a replication policy specifies that the object is to be replicated from a first object store to one or more other object stores, but replication of the object according to the replication policy to the one or more other object stores has not yet completed. Note that when a new object is added to the first object store, the replication policy can specify that the new object is to be replicated to the one or more other object stores. As another example, when an existing object in the first object store is updated, the replication policy can specify that the updated object is to be replicated to the one or more other object stores. As a further example, when an existing object in the first object store is deleted, the replication policy can specify that the deletion of the object is to be replicated to the one or more other object stores. Thus, replication of an object (or object collection) can refer to replication of a new object or an updated object, or replication of a deletion of an object.

As the replication of a given object according to the replication policy is completed, the ORD can remove tracking information for the given object from the ORD. In some cases, the tracking information maintained at the ORD for each object can have several elements. When replication of the given object is completed (caught up), the ORD can choose to remove all of the tracking information from the ORD, or alternatively, the ORD can choose to remove just a subset of the tracking information, while keeping the remainder of the tracking information for the given object. Note that tracking information can be associated with each individual object or with a collection of objects.

While in some examples the tracking information at the ORD is transient, in further examples, the ORD may choose to persist some or all of the tracking information. As examples, the high-level replication information among all object stores is persistently stored in the ORD along with the associated object's user access control privileges.

The tracking information is useable by the ORD to process read and write accesses from control interfaces for objects not found by the control interfaces in their associated object stores of the control interfaces. As an example, an object store associated with a control interface can be a local object store managed by the control interface. In some examples, a portion of the tracking information stored in ORD (e.g., in persistent storage) can further be cached in a cache memory. The cached tracking information in the cache memory allows for faster access of objects since the cache memory can be more quickly accessed by the ORD than other types of storage.

Additionally, when a control interface for an associated object store receives an access request for an object, the control interface first checks if the object is locally stored in the associated object store, and if not, the control interface consults the ORD. The ORD can redirect the control interface to another control interface associated with another object store that has the requested object when, for example, the requested object is accessible at the object store but is not yet stored at that object store (e.g., when a copy of the object is to be replicated to the object store but has not yet arrived at the object store).

Note that the actual data (objects) do not pass through the ORD. The ORD provides coordination among the control interfaces, such as to redirect a first control interface to a second object store to obtain an object that is not found locally in the first object store.

In some cases, the ORD can go down. In response to detecting that the ORD is down, a control interface for an object store handles I/O requests from host systems locally. Specifically, in response to an I/O read request to read a given object, the control interface determines whether the given object is present in the object store associated with the control interface. If so, the control interface retrieves the given object and sends an I/O response including the given object to the requesting host system. If the given object is not in the object store, the control interface 302 sends, to the requesting host system, an I/O response that includes an object not found error.

As used here, a “control interface” refers to any type of interface accessible by a host system to access an object store. The control interface may be part of a storage controller of the object store, and in some cases may be the storage controller of the object store. Alternatively, the control interface may be separate from the storage controller of the object store.

In some examples where object stores are S3 object stores, the control interface can include an S3 control interface. In other examples, other types of control interface protocols can be employed. Host systems are able to interact with the control interfaces using messages according to a specified protocol, which can be a standardized protocol, an open-source protocol, or a proprietary protocol of an enterprise. An object store can offer one more than one access protocol at the same time.

If a first control interface associated with a first object store receives a read request for an object, the first control interface checks to determine if the requested object is present in the first object store. Typically, if the object is not found or when the object or corresponding group of object groups is blocked, the first control interface responds with an object not found error. In examples of the present disclosure, if the first control interface does not find the object locally in the associated object store, the first control interface can issue a query to the ORD to request assistance in finding the requested object. The ORD can determine (based on its tracking information) which object store (if any) has the requested object. If the requested object is found by the ORD in a second object store, the ORD can inform the first control interface about the object location so that the first control interface can redirect a remote read from a second control interface associated with the second object store. If the ORD determines that multiple other object stores have the requested object, the ORD can decide which target object store to use to retrieve the requested object. This decision be based on any or some combination of various criteria, including a least busy criterion, or a closest to requester criterion, or load balancing criterion, and so forth.

Further, the ORD can manage a replication policy for objects and can control the replication of objects respective object store. The ORD is the central source of knowledge regarding replication of objects. As an example, an administrator can indicate to the ORD a new or updated replication policy specifying that an object, a group of objects, or an object store is to be replicated. In response, the ORD can inform control interfaces of respective object stores of the new or updated replication policy. Upon notification of the new or updated replication policy, any subsequent requests from host systems for objects subject to the new or updated replication policy can be redirected to the ORD even before completion of replication of the affected objects, so that control interfaces would not have to respond to the host systems with an object not found error.

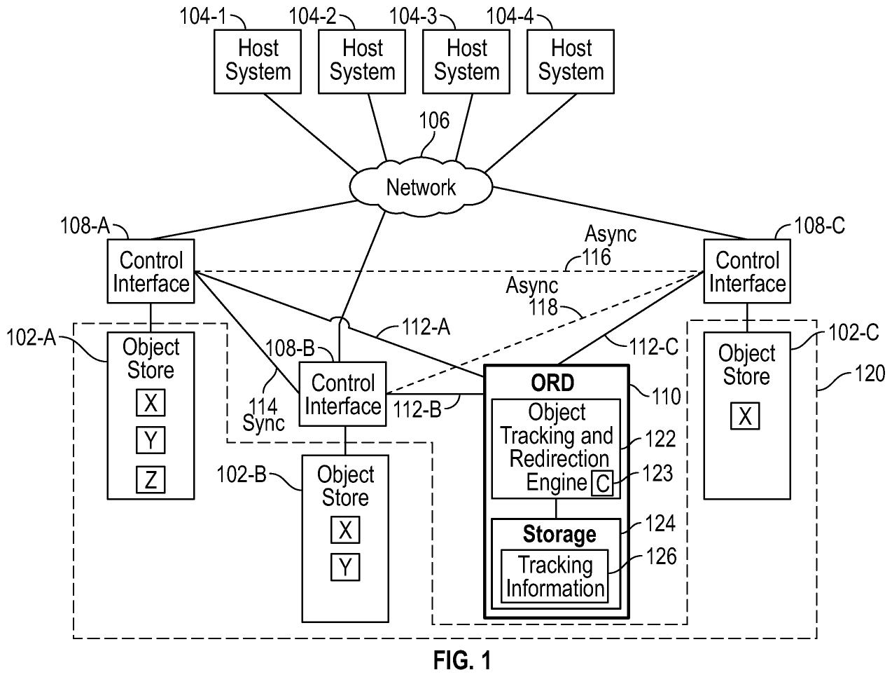

FIG. 1 is a block diagram of an example arrangement that includes a quantity of object stores 102-A, 102-B, and 102-C. Although FIG. 1 shows an example that includes 3 object stores, in other examples, different quantities of object stores may be provided. The object stores 102-A, 102-The, and 102-C are accessible by host systems 104-1, 104-2, 104-3, and 104-4 over a network 106. Although FIG. 1 shows an example with 4 host systems, in other examples, different quantities of host systems can be provided.

Examples of the network 106 can include any or some combination of the following: a local area network (LAN), a storage area network (SAN), a wide area network (WAN), a public network such as the Internet, and so forth.

Each host system is able to issue I/O requests to one or more of the object stores 102-A, 102-B, and 102-C. More specifically, an entity within each host system is able to issue an I/O request. Examples of entities in host systems can include any or some combination of the following: a program (machine-readable instructions including software and firmware), a hardware device, a virtual entity such as a virtual machine (VM) or container, and so forth.

Each of the object stores 102-A, 102-B, and 102-C is associated with a respective control interface 108-A, 108-B, 104 and 108-C, where each control interface may be included in an object store (e.g., part of the storage controller of the object store) or external of the object store. A host system sends an I/O request to a respective control interface to access an object in the corresponding object store. Thus, for example, a host system sends an I/O request to the control interface 108-A to access an object in the object store 102-A, a host system sends an I/O request to the control interface 108-B to access an object in the object store 102-B, and so forth.

In accordance with some implementations of the present disclosure an ORD 110 is provided that has communication links 112-A, 112-B, and 112-C to the respective control interfaces 108-A, 108-B, and 108-C. The ORD 110 is able to communicate with the corresponding control interfaces 108-A, 108-E, and 108-C over the communication links 112-A, 112-B, and 112-C.

In examples according to FIG. 1, synchronous replication (114) is performed from the object store 102-A to the to the object store 102-B (and possibly vice versa). Asynchronous replication (116) is performed from the object store 102-A to the object store 102-C (and possibly vice versa), and asynchronous replication (118) is performed from the object store 102-B to the object store 102-C (and possibly vice versa).

Communication links over which the replications (114, 116, 118) are performed between object stores are referred to as “replication links.”

In the example of FIG. 1, objects X, Y, and Z are stored in the object store 102-A, objects X and Y are stored in the object store 102-B, and object X is stored in the object store 102-C. Objects X and Y in the object store 102-B can be copies of objects X and Y in the object store 102-A, replicated according to the synchronous replication 114. Object X in the object store 102-C can be a copy of object X in the object store 102-A, replicated according to the asynchronous replication 116.

Although reference is made to maintaining synchronous and asynchronous replications between specific object stores, in other examples, other types of replication policies can be established between the object stores. In some cases, an object store may be associated with a no replication policy, where writes of the objects to the object store are not replicated to other object stores.

Collectively, the object stores 102-A, 102-B, and 102-C form a group of object stores 120 where data replication can be performed members of the group.

In some examples, the communication links 112-A, 112-B, and 112-C are out-of-band communication links separate from replication links among the control interfaces 108-A to 108-C over which data replications (114, 116, 118) occur.

The ORD 110 can be implemented using a computer system, which can include a switch, a computer or multiple computers. The ORD 110 includes an object tracking and redirection engine 122 to track objects in the object stores and to redirect I/O access requests as appropriate.

As used here, an “engine” can refer to one or more hardware processing circuits, which can include any or some combination of a microprocessor, a core of a multi-core microprocessor, a microcontroller, a programmable integrated circuit, a programmable gate array, or another hardware processing circuit. Alternatively, an “engine” can refer to a combination of one or more hardware processing circuits and machine-readable instructions (software and/or firmware) executable on the one or more hardware processing circuits.

Note that the ORD 110 in some examples can include multiple ORD instances, such as to provide redundancy in case of a fault of any of the ORD instances, or to provide load balancing. In further examples, the ORD 110 can be implemented in a VM or a container (or multiple instances of the ORD 110 can be implemented in multiple VMs or containers).

The ORD 110 also includes a storage 124 (e.g., a persistent storage) to store tracking information 126 for objects (individual objects or collections of objects) in a transient condition. The storage 124 can be implemented using a collection of storage devices (a single storage device or multiple storage devices). Examples of storage devices can include any or some combination of the following: a disk-based storage, a solid-state drive, or another type of persistent storage.

The tracking information 126 can track which object store of the group of object stores 120 stores any given object, as well as a replication policy associated with the given object. The tracking information 126 maintained by the ORD 110 includes metadata for objects in the transient condition that have not yet been replicated to object stores according to one or more replication policies.

Since the tracking information 126 stores metadata (and not the objects themselves), the size of the tracking information 126 is relatively small, as compared to the sizes of the object stores 102-A to 102-C. The tracking information 126 can be stored in the storage 124 outside the object stores 102-A to 102-C, and can be accessed quickly by the control interfaces 108-A to 108-C over the communication links 112-A, 112-B, and 112-C. In some examples, the storage 124 can be implemented in a distributed arrangement of storage devices.

When a host system issues an I/O request (read request or write request) to a control interface (108-A, 108-B, or 108-C), the control interface checks to determine if the requested object is present in the associated object store. If the control interface does not find the object locally in the associated object store, the control interface can issue a query to the ORD 110 to request assistance in finding the requested object. The ORD 110 can determine (based on the tracking information 126) which object store(s) (if any) has the requested object, and can redirect the control interface to one of the object store(s).

The ORD 110 and the control interfaces 108-A, 108-B, and 108-C are considered to be synchronized with one another when replication of objects across object stores according to the replication policy has completed. However, a transient condition may exist at the ORD 110 when (1) copies of objects according to the replication policy have not yet propagated to one or more destination object stores (e.g., communications over communication links are slow and/or there are a large quantity of objects to replicate), or (2) when the replication policy has been changed that results in a change to or addition of one or more object stores in which case some amount of latency is involved in completing the replication of objects according to the changed replication policy. For example, a change in the replication policy can involve adding a new object store. The ORD 110 can determine based on the changed replication policy which objects should be replicated to the new object store. The ORD 110 can update the tracking information for the objects that should be replicated to the new object store. During the transient condition at the ORD 110 while object replication is running behind, a control interface that is unable to satisfy an I/O request for an object would seek assistance with the ORD 110 as noted above, and the ORD 110 can direct the control interface to another control interface based on the tracking information 126 for objects in the transient condition.

The object tracking and redirection engine 122 further includes a cache 123 that can cache a portion of the tracking information 126 stored in the storage 124. The cache memory 123 can be part of the object tracking and redirection engine 122 or is accessible by the object tracking and redirection engine 122. The cache memory 123 can be implemented using faster memory than the storage 124. The cached tracking information can be accessed more quickly by the object tracking and redirection engine 122 than the tracking information 126 in the storage 126. As the cache memory 123 fills up, a portion of the cached tracking information can be flushed to the storage 124. The cached tracking information is useable by the object tracking and redirection engine 122 to respond to queries from control interfaces for objects not found by the control interfaces in their associated object stores. The cached tracking information 123 allows for faster access of objects that have not yet completed replication.

Example Tracking Information

Examples of elements of tracking information are discussed below in connection with FIG. 2A. In other examples, the tracking information can have different forms from that depicted in FIG. 2A. For example, rather than store tracking information at the granularity of individual objects, tracking information can be maintained for a larger collection of objects (e.g., the entire object store or some other portion of the object store).

Referring further to FIG. 2A, for a given object (e.g., Object X), an entry 202-1 of the tracking information 126 maintained at the ORD 110 can include object store identifier(s) 204 to identify object store(s) where Object X is stored, and replication information 206 for Object X. An object store identifier can include any or some combination of the following: network address (e.g., an Internet Protocol (IP) address, or a Medium Access Control (MAC) address, etc.), a globally unique identifier, a Uniform Resource Locator (URL), a name, or any other type of identifier.

The replication information 206 can specify the replication policy for Object X, such as whether the replication is synchronous replication or asynchronous replication (or even no replication), and can identify the object stores involved in the replication policy.

In some examples, the tracking information 126 can also maintain version information for each object, to track different versions of the object. The entry 202-1 for Object X includes version information 208 for Object X.

As objects are WORM (write once, read many), when an object is updated, there is an older version of the object (prior to the update) and a newer version of the object (after the update). As the object is updated multiple times, there can be a corresponding number of different versions. Version information can be maintained for objects for programs in the host systems 104-1 to 104-4 that support object versioning. Some programs may not support object versioning, in which case an update of an object would produce a new object. If programs in the host systems 104-1 to 104-4 do not support version information, then the tracking information 126 may or may not expose the version information for the objects to the host systems.

As the control interfaces 108-A to 108-C add or delete objects, the control interfaces 108-A to 108-C send indications of object additions or deletions to the ORD 110. In response to the indications of object additions or deletions, the object tracking and redirection engine 122 updates the tracking information 126. For an object addition, the object tracking and redirection engine 122 can add metadata for the added object to the tracking information 126. For an object deletion, the object tracking and redirection engine 122 can remove metadata for the deleted object from the tracking information 126.

In addition, in response to an indication of object deletion of a given object, the object tracking and redirection engine 122 can consult the metadata for the given object in the tracking information 126, and can identify based on the replication information for the given object which other object store(s) contain(s) a copy of the given object. The object tracking and redirection engine 122 can send an indication of object deletion of the given object to each control interface of the other object store(s) that contain(s) a copy of the given object, to cause deletion of the copy of the given object at the other object store(s).

In examples where programs in the host systems 104-1 to 104-4 support object versioning, the control interfaces 108-A to 108-C can also send indications of object updates to the ORD 110. In response to the indications of object updates, the object tracking and redirection engine 122 can add version information for each object updated.

In some examples, the tracking information 126 can also keep track of buckets associated with objects. A bucket is a logical representation of an object set that can include one object or multiple objects. When a host system is writing to a bucket, a lock may be placed on the object(s) being written in the bucket to prevent another host system from accessing the object(s) while being updated in the bucket. In other examples, such bucket locks are not used. In examples where buckets are used, the entry 202-1 for Object X contains bucket information 210 to identify a bucket where Object X is contained. In some examples, the buckets are S3C buckets, and the bucket information 210 can include bucket names.

Further, in examples where buckets are supported, buckets can be added to an object store or deleted from the object store by host systems. In such examples, the tracking information 126 can be similarly updated by the ORD 110 in response to additions or deletions of buckets. More generally, various operations discussed herein relating to objects can also be applied to buckets.

Since the size of the tracking information 126 is relatively small as it contains basic object location and object stores relationship to each other as compared to the sizes of the object stores 102-A to 102-C, the update of the tracking information 126 is relatively lightweight.

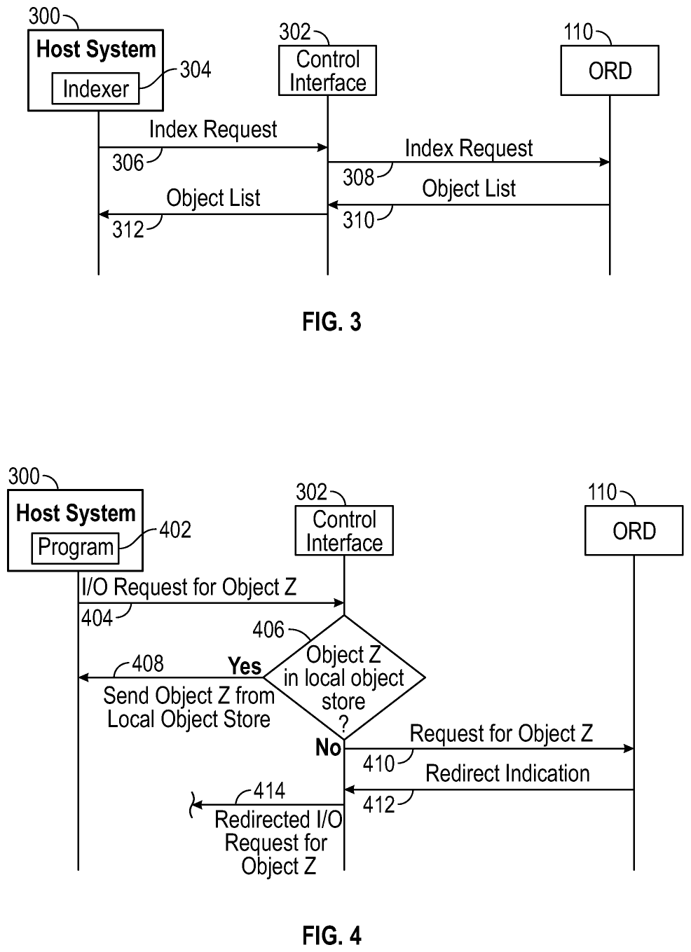

Note also that the ORD 110 is consulted in two cases: 1) when performing indexing (discussed further below in connection with FIG. 3), or 2) when an object is not found in the object store of a control interface (e.g. when the ORD 110 is in the transient condition noted above).

In some examples, the tracking information 126 can also keep track of access costs associated with respective objects. In FIG. 2A, the entry 202-1 for Object X contains access cost information 212. An access cost for an object can be calculated based on any or some combination of the following factors: last known network latency in accessing the object, last known access latency of an object store that contains the object, an access speed associated with a type of storage device(s) used to implement the object store, how busy a communication link is to the object store, or any other factor. In examples where an object is replicated, access cost information is also maintained for each copy of the object. A control interface can access the tracking information 126 to determine an access cost of a given object (and any copies of the given object). Based on the access cost, the control interface can decide where to obtain the given object to satisfy a request for the given object from a host system.

Although specific examples of various metadata for an object is depicted in FIG. 2A, in other examples, alternative or additional metadata can be included in the tracking information 126. Other metadata can include an indication of whether an object is compressed, an object's protection level in the object store, analytics information about the object, and so forth.

Similar metadata for other objects, including Object N, can be maintained in other entries, including entry 202-N, of the tracking information 126.

FIG. 2B shows an example of tracking information 210 that can be maintained at a control interface (e.g., 108-A, 108-B, or 108-C). The tracking information 210 contains similar entries 212-1 to 212-M for respective objects A to E (each entry including an object store ID 214, replication information 216, version information 218, bucket information 220) as the tracking information 126 of FIG. 2A, except that the tracking information 210 at the control interface does not include access cost information, and the object store ID 214 identifies the object store associated with the control interface. In response to an I/O request for an object, the control interface uses the tracking information 210 to determine whether the requested object is in the associated object store.

Indexing

FIG. 3 shows an example of an indexing operation initiated by an indexer 304 in a host system 300 (which can be any one of the host systems 104-1 to 104-4 of FIG. 1). An indexing operation is to identify objects stored in an object store, to build a list of the objects in the object store. The indexer 304 sends (at 306) an index request to a control interface 302 of an object store for which the indexer 304 desires to build a list of objects. The control interface 302 redirects (at 308) the index request to the ORD 110. The tracking information 126 maintained by the ORD 110 may identify objects in the transient condition that the control interface 302 may not be aware of should have been replicated to the object store associated with the control interface 302. Without first consulting the ORD 110, the control interface 302 may not be able to provide a full list of the objects that should be stored by the object store associated with the control interface 302. In response to the index request (at 308), the object tracking and redirection engine 122 in the ORD 110 is able create a list of the objects in the transient condition that should be stored in the object store. The ORD 110 sends (at 310), to the control interface 302, the object list that identifies objects in the transient condition store identified by the index request to the control interface 302. The control interface 302 creates the full list of objects (including objects at the object store as well as the objects in the transient condition identified by the ORD 110) and sends (at 312) the object list to the host system 300. In addition to identifiers of the objects, the object list can also include other information related to the objects, such as names of the objects, sizes of the objects, revisions of the objects, access permissions of the objects, and so forth. The object list is stored by the host system 300 to allow the host system 300 to be aware of where objects are stored.

Object Replication

In some cases, object replication between object stores can be performed as a background process, such as in the case of asynchronous replication. In some cases, replication of objects may occur out of order with respect to an order in which writes of the objects occurred to an object store. For example, a host system may add objects 1, 2, 3, . . . , 30 to a first object store, and the objects are associated with an asynchronous replication policy to replicate the objects to a second object store. The replication of objects can occur in the background. In some cases, a given object (e.g., object 12) may be replicated out of order (an order different from 1, 2, 3, . . . , 30), such as when a host system attempts to access object 12 at the second object store but the second object store does not have a copy of object 12. In such a scenario, a copy of object 12 may be transferred to the control interface for the second object store to satisfy the request for object 12, which can occur before all of objects 1 to 11 have been replicated. Once a copy of object 12 is transferred to the control interface for the second object store and stored in the second object store, the ORD 110 can notify the control interface for the first object store that replication of object 12 has completed, such that the control interface for the first object store would not have to replicate object 12 again after objects 1 to 11 are replicated to the second object store. For example, the ORD 110 can indicate to the control interface for the first object store that the control interface is out of replication compliance with respect to objects 1, 2, 3, . . . , 30, and can identify which objects are missing (e.g., objects 1 to 11).

In some cases, a replication policy for a given object can be modified, such as by a user or another entity (a program or machine). The modification of the replication policy can cause a copy of the given object to be added to object store P while a copy of the given object is removed from object store Q. The modification of the replication policy may be performed for any of various reasons, such as to move the copy of the given object to an object store where it is more frequently accessed by host systems, to move the copy of the given object to an object store that is less costly or has a higher access speed or that is less burdened, to move the copy of the given object to an object store with a target retention policy, and so forth. As a result of the modification of the replication policy for the given object, the user or other entity can inform the ORD 110, which can update the tracking information 126 accordingly.

Object Access

FIG. 4 shows an example of a program 402 in the host system 300 sending (at 404) an I/O request (e.g., read request or write request) to the control interface 302, to access Object Z in the local object store associated with the control interface 302. If the local object store associated with the control interface 302 is the object store 102-C, then Object Z would not be in the object store 102-C (as depicted in FIG. 1), such as due to the replication of Object Z to the object store 102-C not yet being complete. If Object Z is in the local object store, as determined (at 406), then the control interface 302 would send (at 408) Object Z to the host system 300. If Object Z is not in the local object store, without the ORD 110, the control interface 302 may return an object not found error to the host system 300. However, in accordance with some examples of the present disclosure, a control interface is not allowed to respond back to any I/O request with an object not found error unless the control interface consults with the ORD 110 first to check whether the requested object is present in any other object store.

In response to detecting that Object Z is not in the local object store (such as based on the tracking information 210 of FIG. 2B), the control interface 302 sends (at 410) a request for Object Z to the ORD 110. The object tracking and redirection engine 122 in the ORD 110 responds to the request for Object Z by sending (at 412) a redirect indication to the control interface 302. The redirect indication can be in the form of a message, an information element, or any other indicator. The redirect indication can identify a target object store (e.g., the object store 102-A) to which the control interface 302 is to redirect the I/O request for Object Z. The object tracking and redirection engine 122 can determine which object store stores Object Z based on the tracking information 126.

In response to the redirect indication, the control interface 302 sends (at 414) a redirected I/O request for Object Z to a target control interface associated the target object store identified in the redirect indication. The target control interface retrieves Object Z from the associated object store, and either (1) sends Object Z to the control interface 302, which returns Object Z to the host system 300, or (2) sends Object Z directly to the host system 300.

To support case (2) above, the host system 300 (or the program 402 in the host system 300) is configured to support interaction with multiple object stores.

To support case (1) above, the control interface 302 performs a proxy read of Object Z from the target object store. In this case, the control interface 302 can emulate a host access (i.e., the redirected I/O request for Object Z appears to the target control interface to be from a host system).

In some examples, assuming that a replication policy specifies that the local object store is to store a copy of Object Z, the control interface 302 can store a copy of Object Z retrieved from the target object store in the local object store associated with the control interface 302. After storing the copy of Object Z locally, the control interface 302 can notify the ORD 110 of the replication of Object Z at the local object store associated with the control interface 302, and the ORD 110 can update the tracking information 126 accordingly. The reason that a copy of Object Z is not yet in the local object store according to the replication policy is that data replication of Object Z may have fallen behind, due to heavy workload or a replication link being down. The storing of the copy of Object Z in the local object store is an opportunistic out-of-order replication of Object Z (resulting in the out-of-order replication as discussed further above) while retrieving Object Z for the host system 300.

In other examples, the replication policy does not specify that the local object store is to store a copy of Object Z. Alternatively, Object Z may not have a replication policy. In such examples, instead of storing the copy of Object Z in the local object store and notifying the ORD 110 of such replication, the copy of Object Z can be stored instead in a local cache memory of the control interface 302. This can allow for a faster access of Object Z in the future in response to an I/O request for Object Z from a host system.

Alternatively, the replication policy may be updated to move a copy of Object Z to the local object store, such as in response to detecting that more than some threshold quantity of I/O requests have been received for Object Z at the control interface 302. The change in the replication policy to place a copy of Object Z at the local data store can reduce read latency in accessing Object Z.

If instead of the redirect indication the ORD 110 responded with an indication that the requested object is not in any of the object stores of the group of object stores 120, the control interface 302 can respond to the host system 300 with an object not found error.

In some examples, in response to the request for Object Z (410) from the control interface 302, the object tracking and redirection engine 122 may determine from the tracking information 126 that multiple object stores contain Object Z. In such examples, the object tracking and redirection engine 122 can select one of the multiple object stores according to a criterion, which can include proximity and/or access cost. For example, the object tracking and redirection engine 122 can compare proximities of the multiple object stores to the control interface 302, where “proximity” can refer to geographic proximity (e.g., smaller physical distance is more preferable), a number of network hops (e.g., a smaller number of network hops is more preferable), and so forth. The object store selected can be the one that is most proximal to the control interface 302. Alternatively or additionally, the object tracking and redirection engine 122 can compare access costs associated with accessing Object Z from the multiple object stores; the object store selected can be the one associated with a lower access cost, for example.

Assuming that all of the replication links (114, 116, and 118) are operational and the ORD 110 is operational, then any of the host systems 104-1 to 104-4 of FIG. 1 can access any of Objects X, Y, and Z, either directly or indirectly through redirection by the ORD 110.

For example, the host system 104-1 can access Objects X, Y, and Z directly from the object store 102-A by sending I/O requests to the control interface 108-A. The host system 104-2 can access Objects X and Y directly from object store 102-B by sending I/O requests to the control interface 108-B. The host system 104-2 can access Object Z indirectly by sending an I/O request for Object Z to the control interface 108-B, which will consult the ORD 110 at which point the ORD 110 will redirect the control interface 108-B to access Object Z from the object store 102-A.

Example Failure or Exception Scenarios

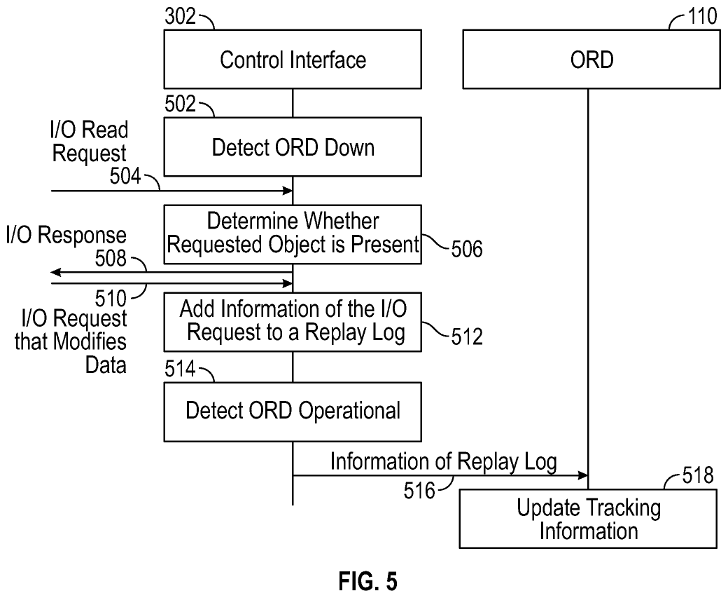

FIG. 5 is a flow diagram of a process performed in response to the ORD 110 being down. The control interface 302 detects (at 502) that the ORD 110 is down. For example, a heartbeat mechanism can be used where the ORD 110 can periodically send heartbeat messages to each control interface. Failure to receive a heartbeat message (or some specified quantity of heartbeat messages) is an indication to the control interface that the ORD 110 is down.

In response to detecting that the ORD 110 is down, the control interface 302 handles I/O requests from host systems as the control interface 302 normally would. Specifically, in response to an I/O read request (received at 504) to read a given object, the control interface 302 determines (at 506) whether the given object is present in the object store associated with the control interface 302. If so, the control interface 302 retrieves the given object and sends (at 508) an I/O response including the given object to the requesting host system. If the given object is not in the object store, the control interface 302 sends (at 508), to the requesting host system, an I/O response that includes an object not found error.

In addition, in response to receiving (at 510) an I/O request that modifies data (e.g., an I/O request to add an object or an I/O request to delete an object), the control interface 302 logs (at 512) information of the I/O request that modifies data into a replay log, which is a data structure (e.g., stored in a memory of the control interface 302) that contains information of objects added to or deleted from the object store associated with the control interface 302.

At a subsequent time, the control interface 302 detects (at 514) that the ORD 110 is operational. In response, the control interface 302 sends (at 516) the information in the replay log to the ORD 110. The ORD 110 can merge information from replay logs from different control interfaces, and can update (at 518) the tracking information 126 based on the merged information.

In a different example, some or all of the replication links (e.g., 114, 116, and 118) between the object stores may be down. If all objects were successfully replicated prior to the replication link(s) going down, then a control interface can process I/O requests by retrieving the objects either directly or indirectly based on redirection from the ORD 110.

However, if a particular object was not replicated successfully according to a replication policy prior to the replication link(s) going down, then a control interface can send an indication of the failed replication to the ORD 110, which can record in the tracking information 126 that a replication of the particular object has not yet occurred. When redirecting I/O requests, the ORD 110 can take into account the fact that the particular object has not yet been replicated according to the replication policy.

In some cases, a control interface may receive an I/O request to add an object to an object store that does not belong to the object store. This is an example of an exception scenario. As an example, the control interface 108-C of FIG. 1 may receive an I/O request to add Object Z to the object store 102-C. However, a configuration of the group of object stores 120 may specify that Objects X, Y, Z are stored in the object store 102-A, Objects X and Y are stored in the object store 102-B, and Object X is stored in the object store 102-C. Thus, according to this configuration, Object Z does not belong to the object store 102-C.

Several possible actions may be performed in response to the I/O request to add Object Z to the object store 102-C. A first action can be a rejection of the I/O request by the control interface 108-C, so that Object Z is not stored in the object store 102-C. A second action may be to accept the I/O request by the control interface 108-C, which stores Object Z in the object store 102-C. In the latter case, the control interface 108-C sends an addition indication for Object Z to the ORD 110, which updates the tracking information 126 to reflect that a copy of Object Z is also present in the object store 102-C. A third action may be that the control interface 108-C forwards the I/O request to the ORD 110, which can then redirect to adding of Object Z to the appropriate object store (e.g., 102-A).

In another example, a host system may issue an I/O request to add a new version of an object while the ORD 110 is operational but some or all of the replication links (114, 116, 118) are down. In response to the I/O request to add the new version of the object, the ORD 110 updates the tracking information 126. However, since some or all replication links are down, a copy of the new version of the object may not be replicated successfully. The ORD 110 can keep track of this situation, and can redirect an I/O request to access the object to the object store with the latest version. In some examples, in response to the I/O request to add the new version of the object, the ORD 110 can propagate indications to the appropriate control interfaces to delete older versions of the object. When the replication links all become operational, replication can proceed and the ORD 110 can update the tracking information 126 to note the replication.

In a further example, a host system may issue an I/O request to add a new version of an object while the ORD 110 is down and all of the replication links (114, 116, 118) are down. In such a scenario, each control interface can process I/O requests as normally, returning objects from its associated object store if the objects are in the associated object store, and returning an object not found error if a requested object is not in the associated object store (note that the ORD 110 is down and unable to redirect in this scenario).

If a program in a host system does not support object versioning, then it is possible for the program to send a request to an object store that stores an older version of an object (i.e., another object store stores a newer version of the object but because the replication links are down replication has not occurred and because the ORD 110 is down the ORD 110 is unable to redirect to the newest version of the object). In this case, the program when receiving the older version of the object may perform a check to determine whether the object is the newest version. For example, the program may check the size of the object or compute a checksum of the object; if the size or checksum does not match an expected size or expected checksum, respectively, then the program can reject the older version of the object. The expected size or expected checksum may have communicated to the program, such as from another program that added the newer version of the object.

In some examples, the ORD 110 can play the role of a data replication quorum witness, which is an entity that monitors object stores that employ synchronous replication in an active-active arrangement. In the active-active arrangement, each of the object stores that perform synchronous replication is considered to be “active,” i.e., a host system can access the data in any of the active object stores. An active-active arrangement is distinguished from an active-standby arrangement, where a host system can access objects from the active object store but not from the standby object store, unless the active object store becomes unavailable.

In an example, object store P and object store Q are in an active-active arrangement where synchronous replication occurs from P to Q. If synchronous replication of objects is from P to Q, then object store P is the primary object store and object store Q is the secondary object store in the active-active arrangement. With such an arrangement, synchronous active-active replication occurs between object stores P and Q.

If the ORD 110 detects that a replication link between object store P and object store Q is down (where object stores P and Q are active-active object stores and synchronous replication is from P to Q), such that replication of objects is not being performed, then the ORD 110 can redirect host accesses of objects received at object store Q to object store P.

Also, if the ORD 110 observes that accesses of objects of a given bucket are being redirected too often (e.g., more than 50% or some other threshold amount of accesses of objects of the given bucket are being redirected from Q to P for example), then the ORD 110 can failover the given bucket from P to Q so that object store Q becomes the primary object store for the given bucket and P becomes the secondary object store in the active-active arrangement. This can reduce the number of redirections and improve access latency and reduce use of network bandwidth.

Global Namespace

A namespace includes a set of names that are used to identify and refer to objects. Within a namespace, each object has a unique name so that the object can be identified and distinguished from another object identified by the namespace. Each respective object store (e.g., 102-A, 102-B, 102-C in FIG. 1) has its respective namespace including names of respective objects in the respective object store.

In accordance with some implementations of the present disclosure, the ORD 110 can aggregate object store namespaces of multiple object stores to produce a global namespace with names of the objects of the multiple object stores. The object store namespaces are provided by respective control interfaces 108-A, 108-B, and 108-C. The global namespace is provided by the ORD 110 without merging the object store namespaces. In other words, the ORD 110 can gather the names of objects from the object store namespaces to include in the global namespace, but the object store namespaces themselves remain separate from one another (i.e., they are not merged). When two namespaces are merged, each namespace becomes a permanent contributor to the merged namespace. By aggregating object store namespaces without merging, the ORD 110 can add names of an object store namespace to the global namespace or remove names of an object store namespace from the global namespace on a dynamic basis; e.g., the names of a given object store namespaces can be added to the global namespace for a relatively short period of time. The names of an object store namespace can be removed from the global namespace if the respective object store is to be removed from a group of object stores (e.g., 120 in FIG. 1).

### Further Example Implementations

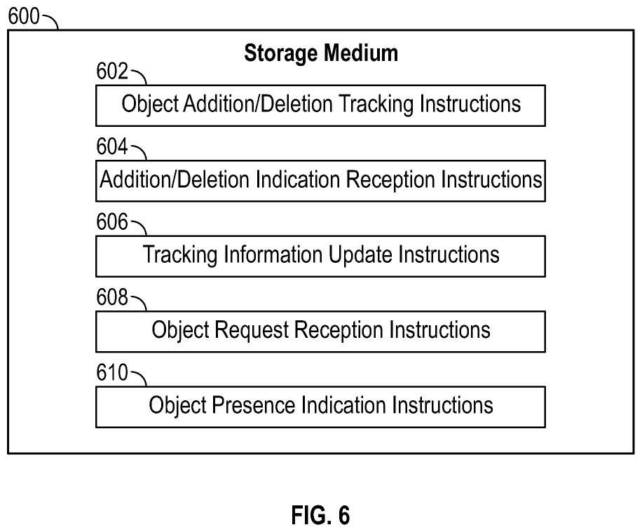

FIG. 6 is a block diagram of a non-transitory machine-readable or computer-readable storage medium 600 storing machine-readable instructions that upon execution cause a system to perform various tasks. The system can include the ORD 110, for example.

The machine-readable instructions include object addition/deletion tracking instructions 602 to track, in tracking information stored by the system, additions and deletions of objects in a plurality of object stores that are associated with respective control interfaces that control access of the objects in the plurality of object stores, the tracking information identifying a respective object store in which a respective object is stored, and a replication policy for the respective object, the replication policy defining how the respective object is replicated across the plurality of object stores. In some examples, the tracking information can include additional metadata, such as version information of objects, bucket information of buckets containing objects, and access cost information.

The machine-readable instructions include addition/deletion indication reception instructions 604 to receive, from the control interfaces, indications of additions or deletions of objects in the plurality of object stores.

The machine-readable instructions include tracking information update instructions 606 to update, at the system, the tracking information in response to the received indications.

The machine-readable instructions include object request reception instructions 608 to receive, at the system from a first control interface of the control interfaces, a request for a given object that the first control interface is to access at a first object store controlled by the first control interface if the given object is in the first object store.

The machine-readable instructions include object presence indication instructions 610 to provide, from the system to the first control interface in response to the request, an indication relating to presence of the given object in any of the plurality of object stores, the indication relating to presence of the given object based on the updated tracking information. In some examples, the indication relating to presence of the given object includes a redirect indication (e.g., sent at 408 in FIG. 4) to redirect the first control interface to a second control interface to access the given object at a second object store. In further examples, the indication relating to presence of the given object from the system to the first control interface includes an indication that the given object is not stored at any of the plurality of object stores.

In some examples, a replication policy for the given object specifies a replication of the given object from the second object store to the first object store, where the redirect indication is to cause access of the given object at the second object store due to the given object not having yet been replicated to the first object store due to a replication link between the first object store and the second object store being down.

In some examples, in response to determining, based on the updated tracking information, that a replication policy for the given object specifies that the given object is replicated at multiple object stores of the plurality of object stores, the machine-readable instructions identify, based on a criterion, a selected object store of the multiple object stores, and provide the redirect indication to redirect the first control interface to the second control interface that controls access to the selected object store.

In some examples, the criterion is based on proximity of each of the multiple object stores to the first control interface or a latency to access each of the multiple object stores.

In some examples, after recovery of the system from an unavailable condition (e.g., the system was down), the machine-readable instructions receive, from each respective control interface of the control interfaces, content of a replay log maintained by the respective control interface while the system was in the unavailable condition, the replay log indicating objects added or deleted at a corresponding object store controlled by the respective control interface.

In some examples, the machine-readable instructions receive, from a control interface of the control interfaces, a request to index objects in a given object store, and provide, in response to the request to index objects, information of objects in the given object store.

In some examples, while one or more replication links between object stores are down, the machine-readable instructions receive, at the system from a given control interface, an indication of a write of a new version of a given object, and in response to a request to access the given object from a further control interface, direct the further control interface to the new version of the first object.

In some examples, the machine-readable instructions present a global namespace to host systems that are able to access the plurality of object stores through the respective control interfaces, the global namespace including information of objects in the plurality of object stores.

In some examples, the global namespace includes an aggregate of object store namespaces maintained by the respective control interfaces, where any object store namespace of the object store namespaces can be dynamically joined to or removed from the global namespace.

In some examples, synchronous active-active replication is provided from the second object store to the first object store such that the second object store is a primary object store in an active-active arrangement, and the first object store is a secondary object store in the active-active arrangement. The machine-readable instructions detect that greater than a specified threshold amount of accesses of objects at the first control interface are redirected to the second a second control interface for a second object store, and in response to the detecting, perform a failover to designate the first object store as the primary object store in the active-active arrangement, and designate the second object store as the secondary object store in the active-active arrangement. The detecting that greater than the specified threshold amount of accesses of objects are redirected can be based on detecting that accesses of objects of a given bucket are being redirected too often (e.g., more than 50% or some other threshold amount of accesses of objects of the given bucket are being redirected from Q to P for example.

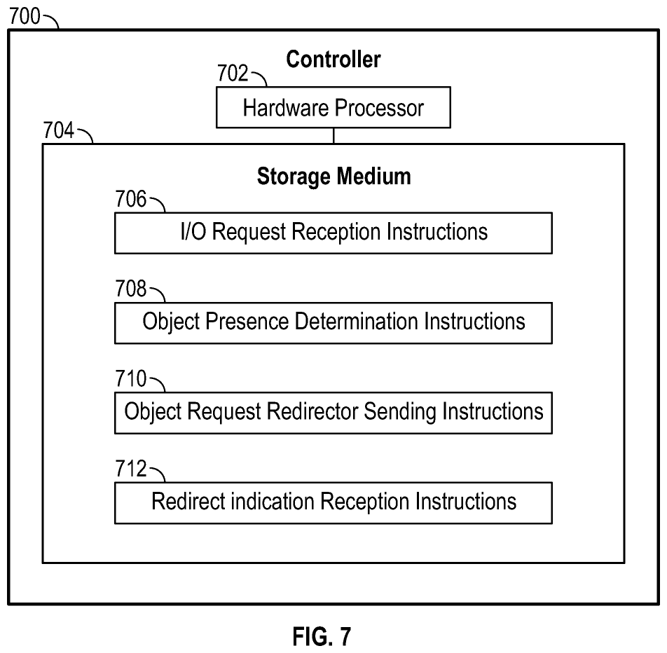

FIG. 7 is a block diagram of a controller 700 according to some examples. The controller 700 can implement a control interface, for example. The controller 700 includes a hardware processor 702 (or multiple hardware processors). A hardware processor can include a microprocessor, a core of a multi-core microprocessor, a microcontroller, a programmable integrated circuit, a programmable gate array, or another hardware processing circuit.

The controller 700 further includes a storage medium 704 storing machine-readable instructions executable on the hardware processor 702 to perform various tasks. Machine-readable instructions executable on a hardware processor can refer to the instructions executable on a single hardware processor or the instructions executable on multiple hardware processors.

The machine-readable instructions in the storage medium 704 include I/O request reception instructions 706 to receive, from a host system, an I/O request to access an object in a first object store.

The machine-readable instructions in the storage medium 704 include object presence determination instructions 708 to determine that the object is not in the first object store. For example, a replication policy may specify that the object is to be replicated from a second object store to the first object store.

The machine-readable instructions in the storage medium 704 include object request redirector sending instructions 710 to send, from the controller to a redirector, a request for the object. The redirector tracks, in tracking information, additions and deletions of objects in a plurality of object stores that are associated with respective controllers that control access of the objects in the plurality of object stores, the tracking information identifying a respective object store in which a respective object is stored, and a replication policy for the respective object, the replication policy defining how the respective object is replicated across the plurality of object stores, where the tracking information is to be updated responsive to indications of additions or deletions of objects in the plurality of object stores from the controllers.

The machine-readable instructions in the storage medium 704 include redirect indication reception instructions 712 to, in response to the request sent from the controller to the redirector, receive a redirect indication to redirect the controller to a second controller to access the object in a second object store.

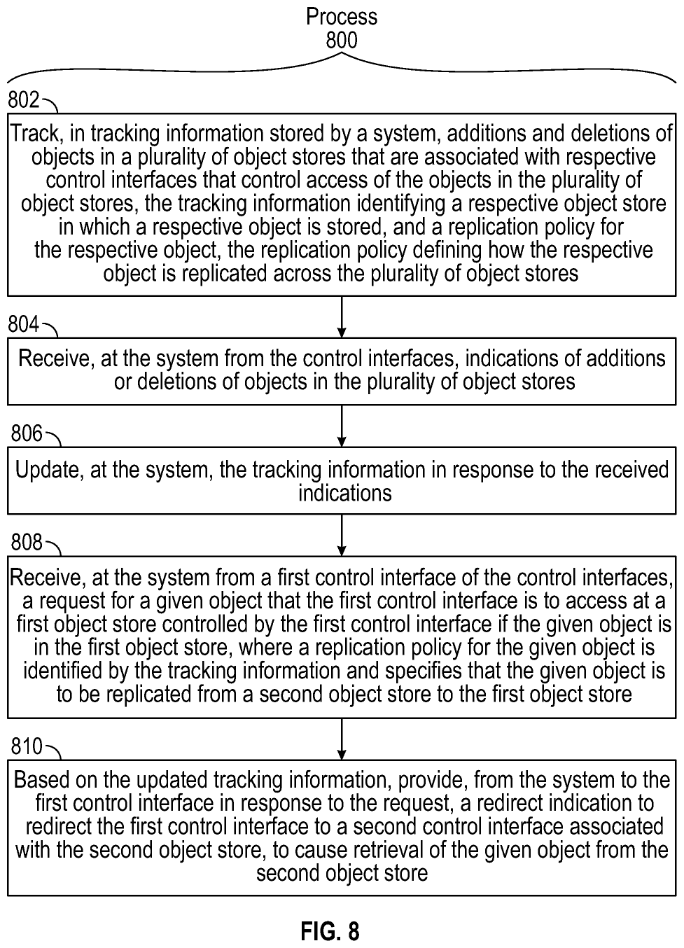

FIG. 8 is a flow diagram of a process 800 according to some examples. The process 800 may be performed by the ORD 110, for example.

The process 800 includes tracking (at 802), in tracking information stored by a system, additions and deletions of objects in a plurality of object stores that are associated with respective control interfaces that control access of the objects in the plurality of object stores, the tracking information identifying a respective object store in which a respective object is stored, and a replication policy for the respective object, the replication policy defining how the respective object is replicated across the plurality of object stores.

The process 800 includes receiving (at 804), at the system from the control interfaces, indications of additions or deletions of objects in the plurality of object stores.

The process 800 includes updating (at 806), at the system, the tracking information in response to the received indications.

The process 800 includes receiving (at 808), at the system from a first control interface of the control interfaces, a request for a given object that the first control interface is to access at a first object store controlled by the first control interface if the given object is in the first object store, where a replication policy for the given object is identified by the tracking information and specifies that the given object is to be replicated from a second object store to the first object store.

The process 800 includes, based on the updated tracking information, providing (at 810), from the system to the first control interface in response to the request, a redirect indication to redirect the first control interface to a second control interface associated with the second object store, to cause a retrieval of the given object from the second object store.

A storage medium (e.g., 600 in FIG. 6 or 704 in FIG. 7) can include any or some combination of the following: a semiconductor memory device such as a DRAM or SRAM, an erasable and programmable read-only memory (EPROM), an electrically erasable and programmable read-only memory (EEPROM) and flash memory; a magnetic disk such as a fixed, floppy and removable disk; another magnetic medium including tape; an optical medium such as a compact disk (CD) or a digital video disk (DVD); or another type of storage device. Note that the instructions discussed above can be provided on one computer-readable or machine-readable storage medium, or alternatively, can be provided on multiple computer-readable or machine-readable storage media distributed in a large system having possibly plural nodes. Such computer-readable or machine-readable storage medium or media is (are) considered to be part of an article (or article of manufacture). An article or article of manufacture can refer to any manufactured single component or multiple components. The storage medium or media can be located either in the machine running the machine-readable instructions, or located at a remote site from which machine-readable instructions can be downloaded over a network for execution.

In the foregoing description, numerous details are set forth to provide an understanding of the subject disclosed herein. However, implementations may be practiced without some of these details. Other implementations may include modifications and variations from the details discussed above. It is intended that the appended claims cover such modifications and variations.

What is claimed is:

1. A non-transitory machine-readable storage medium comprising instructions that upon execution cause a system to:
track, in tracking information stored by the system, additions and deletions of objects in a plurality of object stores that are associated with respective control interfaces that control access of the objects in the plurality of object stores, the tracking information identifying a respective object store in which a respective object is stored, and a replication policy for the respective object, the replication policy defining how the respective object is replicated across the plurality of object stores;
receive, from the control interfaces, indications of additions or deletions of objects in the plurality of object stores, and update, at the system, the tracking information in response to the received indications;
receive, at the system from a first control interface of the control interfaces, a request for a given object that the first control interface is to access at a first object store controlled by the first control interface if the given object is in the first object store; and
provide, from the system to the first control interface in response to the request, an indication relating to presence of the given object in any of the plurality of object stores, the indication relating to presence of the given object based on the updated tracking information.

2. The non-transitory machine-readable storage medium of claim 1, wherein the tracking information is maintained by the system for objects in a transient condition.

3. The non-transitory machine-readable storage medium of claim 1, wherein the indication relating to presence of the given object from the system to the first control interface comprises a redirect indication to redirect the first control interface to a second control interface to access the given object at a second object store.

4. The non-transitory machine-readable storage medium of claim 3, wherein a replication policy for the given object specifies a replication of the given object from the second object store to the first object store, and wherein the redirect indication is to cause access of the given object at the second object store due to the given object not having yet been replicated to the first object store.

5. The non-transitory machine-readable storage medium of claim 3, wherein the instructions upon execution cause the system to:
in response to determining, based on the updated tracking information, that a replication policy for the given object specifies that the given object is replicated at multiple object stores of the plurality of object stores:
identify, based on a criterion, a selected object store of the multiple object stores, and
provide the redirect indication to redirect the first control interface to the second control interface that controls access to the selected object store.

6. The non-transitory machine-readable storage medium of claim 5, wherein the criterion is based on proximity of each of the multiple object stores to the first control interface or a latency to access each of the multiple object stores.

7. The non-transitory machine-readable storage medium of claim 1, wherein the indication relating to presence of the given object from the system to the first control interface comprises an indication that the given object is not stored at any of the plurality of object stores.

8. The non-transitory machine-readable storage medium of claim 1, wherein after recovery of the system from an unavailable condition, the instructions upon execution cause the system to:
receive, from each respective control interface of the control interfaces, content of a replay log maintained by the respective control interface while the system was in the unavailable condition, the replay log indicating objects added or deleted at a corresponding object store controlled by the respective control interface.

9. The non-transitory machine-readable storage medium of claim 1, wherein the instructions upon execution cause the system to:
receive, from a control interface of the control interfaces, a request to index objects in a given object store; and
provide, in response to the request to index objects, information of objects in the given object store.

10. The non-transitory machine-readable storage medium of claim 1, wherein the tracking information contains revision information for an object.

11. The non-transitory machine-readable storage medium of claim 1, wherein the tracking information comprises access cost information that is based on any or some combination of: a latency in access of an object or an object store, how busy a link to an object store is, or an access speed associated with a type of storage device used to implement an object store.

12. The non-transitory machine-readable storage medium of claim 1, wherein the instructions upon execution cause the system to:
while one or more replication links between object stores are down:
receive, at the system from a given control interface, an indication of a write of a new version of a given object, and
in response to a request to access the given object from a further control interface, direct the further control interface to the new version of the given object.

13. The non-transitory machine-readable storage medium of claim 1, wherein the instructions upon execution cause the system to:
present a global namespace to host systems that are able to access the plurality of object stores through the respective control interfaces, the global namespace comprising information of objects in the plurality of object stores.

14. The non-transitory machine-readable storage medium of claim 13, wherein the global namespace comprises an aggregate of object store namespaces maintained by the respective control interfaces, wherein any object store namespace of the object store namespaces can be dynamically joined to or removed from the global namespace.

15. The non-transitory machine-readable storage medium of claim 1, wherein the indications of additions or deletions are received at the system over first links from the control interfaces, the first links being separate from replication links among the control interfaces over which data replications occur.

16. The non-transitory machine-readable storage medium of claim 1, wherein synchronous active-active replication is provided from a second object store to the first object store such that the second object store is a primary object store in an active-active arrangement, and the first object store is a secondary object store in the active-active arrangement, and wherein the instructions upon execution cause the system to:
detect that greater than a specified threshold amount of accesses of objects at the first control interface are redirected to a second control interface for the second object store; and
in response to the detecting, perform a failover to designate the first object store as the primary object store in the active-active arrangement, and designate the second object store as the secondary object store in the active-active arrangement.

17. A controller comprising:
a processor; and
a non-transitory storage medium comprising instructions executable on the processor to:
receive, from a host system, an input/output (I/O) request to access an object in a first object store;
determine that the object is not in the first object store;
send, from the controller to a redirector, a request for the object, the redirector to track, in tracking information, additions and deletions of objects in a plurality of object stores that are associated with respective controllers that control access of the objects in the plurality of object stores, the tracking information identifying a respective object store in which a respective object is stored, and a replication policy for the respective object, the replication policy defining how the respective object is replicated across the plurality of object stores, wherein the tracking information is to be updated responsive to indications of additions or deletions of objects in the plurality of object stores from the controllers; and
in response to the request sent from the controller to the redirector, receive a redirect indication to redirect the controller to a second controller to access the object in a second object store.

18. The controller of claim 17, wherein the instructions are executable on the processor to:
in response to the redirect indication from the redirector, perform a proxy read of the object from the second object store by interacting with the second controller.

19. The controller of claim 18, wherein a replication policy specifies that a copy of the object is to be replicated from the second object store to the first object store, and wherein the instructions are executable on the processor to:
perform an opportunistic replication of the object using the proxy read to store a copy of the object in the first object store, wherein the opportunistic replication of the object causes a replication of the object to occur out of order with respect to a specified order of object replications.

20. A method comprising:
tracking, in tracking information stored by a system comprising a hardware processor, additions and deletions of objects in a plurality of object stores that are associated with respective control interfaces that control access of the objects in the plurality of object stores, the tracking information identifying a respective object store in which a respective object is stored, and a replication policy for the respective object, the replication policy defining how the respective object is replicated across the plurality of object stores;
receiving, at the system from the control interfaces, indications of additions or deletions of objects in the plurality of object stores, and updating, at the system, the tracking information in response to the received indications;
receiving, at the system from a first control interface of the control interfaces, a request for a given object that the first control interface is to access at a first object store controlled by the first control interface if the given object is in the first object store, wherein a replication policy for the given object is identified by the tracking information and specifies that the given object is to be replicated from a second object store to the first object store; and
based on the updated tracking information, provide, from the system to the first control interface in response to the request, a redirect indication to redirect the first control interface to a second control interface associated with the second object store, to cause a retrieval of the given object from the second object store.
